(19) United States
(12) Patent Application Publication
(10) Pub. No.: US 2018/0039046 A1
(43) Pub. Date: Feb. 8, 2018

(54) OPTICAL LENS ASSEMBLY AND ELECTRONIC APPARATUS HAVING THE SAME

(71) Applicant: KOLEN CO., LTD., Gyeonggi-do (KR)

(72) Inventors: Jong Jin Lee, Seoul (KR); Chan Goo Kang, Gyeonggi-do (KR); Seong Hee Bae, Gyeonggi-do (KR)

(21) Appl. No.: 15/665,879

(22) Filed: Aug. 1, 2017

(30) Foreign Application Priority Data
Aug. 3, 2016 (KR) 10-2016-0099065

(51) Int. Cl. G02B 13/00; G02B 9/62

(52) U.S. Cl. CPC G02B 13/0045; G02B 9/62

(57) ABSTRACT

An optical lens assembly and an electronic apparatus having the optical lens assembly are disclosed. The optical lens assembly includes, in order from an object side to an image side, a first lens having a positive refractive power, a second lens having a positive refractive power, a third lens having a negative refractive power, a fourth lens having a negative refractive power, a fifth lens having a positive refractive power and having at least one inflection point on at least one of an object side surface and an image side surface; and a sixth lens having a negative refractive power.

### CROSS-REFERENCE TO RELATED APPLICATION

This application claims the benefit of Korean Patent Application No. 10-2016-0099065, filed on Aug. 3, 2016, in the Korean Intellectual Property Office, the disclosure of which is incorporated herein in its entirety by reference.

### BACKGROUND

### 1. Field

One or more embodiments relate to an optical lens assembly having a wide field of view and an electronic apparatus having the same.

### 2. Description of the Related Art

Various services and additional functions provided by electronic apparatuses have gradually expanded. Electronic apparatuses, for example, mobile devices or user devices, may provide various services through various sensor modules. The electronic apparatus may provide a multimedia service, for example, a photo service or a video service. As the use of electronic apparatuses increases, a camera functionally connected to the electronic apparatus has gradually increased. For example, imaging apparatuses using a solid-state imaging device, such as, a charge-coupled device (CCD) image sensor or a complementary metal-oxide semiconductor (CMOS) image sensor, are widely used. In an imaging apparatus using a solid-state imaging device, such as, a digital camera, an interchangeable lens system, or a video camera, users have a demand for high resolution and high quality. An imaging apparatus using a solid-state imaging device, which is suitable for miniaturization, has recently been applied to a small-sized information terminal including a mobile phone.

There are demands for wide-angle lenses that have excellent resolving power suitable for high resolution of digital cameras and simultaneously have a compact size so that the lenses are easy to carry.

### SUMMARY

One or more embodiments include an optical lens assembly having a wide field of view and a compact size.

One or more embodiments include an electronic apparatus including an optical lens assembly having a wide field of view and a compact size.

Additional aspects will be set forth in part in the description which follows and, in part, will be apparent from the description, or may be learned by practice of the presented embodiments.

According to one or more embodiments, an optical lens assembly includes, in order from an object side to an image side, a first lens having a positive refractive power, a second lens having a positive refractive power, a third lens having a negative refractive power, a fourth lens having a negative refractive power, a fifth lens having a positive refractive power and having at least one inflection point on at least one of an object side surface and an image side surface; and a sixth lens having a negative refractive power.

The optical lens assembly may satisfy an inequality that |Sag_{Min}|+|Sagₘₐₓ|>SagD, in which “Sag_{Min}” denotes a distance from an optical axis to a most concave point of the fifth lens, “Sag_{Max}” denotes a distance from the optical axis to a most convex point of the fifth lens, and “SagD” denotes a distance from the optical axis to a farthest point of an effective diameter of the fifth lens.

The optical lens assembly may satisfy an inequality that 20<FOV/TTL<30, in which “FOV” denotes a field of view and “TTL” denotes an overall length of the optical lens assembly.

The optical lens assembly may satisfy an inequality that 0.6<TTL/ImgH<0.8, in which “TTL” denotes an overall length of the optical lens assembly and “ImgH” denotes an image height.

The optical lens assembly may satisfy an inequality that 0.4<F/ImgH<0.6, in which “F” denotes a focal length and “ImgH” denotes an image height.

The optical lens assembly may satisfy an inequality that 0.3<D1/D6<0.5, in which “D1” denotes an effective diameter of the first lens and “D6” denotes an effective diameter of the sixth lens.

The optical lens assembly may satisfying an inequality that 1.5<(Ind3+Ind4)/2<1.7, in which “Ind3” denotes a refractive index of the third lens and “Ind4” denotes a refractive index of the fourth lens.

The optical lens assembly may have a field of view ranging from about 85 to about 95.

The optical lens assembly may have an F number ranging from about 2.0 to about 2.1.

The second lens may include an image side surface that is convex toward the image side.

The third lens may include an image side surface that is concave toward the image side, and the fourth lens may include a meniscus shape that is convex toward the image side.

According to one or more embodiments, an optical lens assembly includes, in order from an object side to an image side, a first lens having a positive refractive power, a second lens having a positive refractive power, a third lens having a negative refractive power, a fourth lens having a negative refractive power, a fifth lens having a positive refractive power, and a sixth lens having a negative refractive power, in which the optical lens assembly satisfies an inequality that 0.3<D1/D6<0.5, in which “D1” denotes an effective diameter of the first lens and “D6” denotes an effective diameter of the sixth lens.

The optical lens assembly may satisfy an inequality that |Sag_{Min}|+|Sag_{Max}| SagD, in which “Sag_{Min}” denotes a distance from an optical axis to a most concave point of the fifth lens, “Sag_{Max}” denotes a distance from the optical axis to a most convex point of the fifth lens, and “SagD” denotes a distance from the optical axis to a farthest point of an effective diameter of the fifth lens.

The optical lens assembly may satisfy an inequality that 20<FOV/TTL<30, in which “FOV” denotes a field of view and “TTL” denotes an overall length of the optical lens assembly.

The optical lens assembly may satisfy an inequality that 0.6<TTL/ImgH<0.8, in which “TTL” denotes an overall length of the optical lens assembly and “ImgH” denotes an image height.

The optical lens assembly may satisfy an inequality that 0.4<F/ImgH<0.6, in which “F” denotes a focal length and “ImgH” denotes an image height.

The optical lens assembly may have a field of view ranging from about 85 to about 95.

The optical lens assembly may have an F number ranging from about 2.0 to about 2.1.

The second lens may include an image side surface that is convex toward the image side, the third lens may include an image side surface that is concave toward the image side, and the fourth lens may include a meniscus shape that is convex toward the image side.

According to one or more embodiments, an electronic apparatus includes an optical lens assembly and an image sensor capturing an image formed by the optical lens assembly, in which the optical lens assembly includes, in order from an object side to an image side, a first lens having a positive refractive power, a second lens having a positive refractive power, a third lens having a negative refractive power, a fourth lens having a negative refractive power, a fifth lens having a positive refractive power and having at least one inflection point on at least one of an object side surface and an image side surface, and a sixth lens having a negative refractive power.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic structural view of an optical lens assembly according to a first embodiment;

FIG. 2 is a graph respectively showing longitudinal spherical aberration, astigmatic field curves, and distortion of the optical lens assembly of FIG. 1;

FIG. 3 is a schematic structural view of an optical lens assembly according to a second embodiment;

FIG. 4 is a graph respectively showing longitudinal spherical aberration, astigmatic field curves, and distortion of the optical lens assembly of FIG. 3;

FIG. 5 is a schematic structural view of an optical lens assembly according to a third embodiment;

FIG. 6 is a graph respectively showing longitudinal spherical aberration, astigmatic field curves, and distortion of the optical lens assembly of FIG. 5; and

FIG. 7 is a schematic perspective view of an electronic apparatus including an optical lens assembly according to an embodiment.

### DETAILED DESCRIPTION

As the inventive concept allows for various changes and numerous embodiments, optical lens assemblies according to embodiments and an electronic apparatus including the same will be illustrated in the drawings and described in detail in the written description. However, this is not intended to limit the present inventive concept to particular modes of practice, and it is to be appreciated that various modifications, equivalents, and/or alternatives that do not depart from the spirit and technical scope of the present inventive concept are encompassed in the present inventive concept. In the description of the present inventive concept, certain detailed explanations of the related art are omitted when it is deemed that they may unnecessarily obscure the essence of the inventive concept. Throughout the drawings, like reference numerals denote like elements.

In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In the present specification, the expressions such as “A or B,” “at least one of A and/or B,” or “at least one or more of A and/or B” may include all available combinations of items listed together. For example, the expressions such as “A or B,” “at least one of A and B,” or “at least one of A or B” may signify all cases of (1) including at least one A, (2) including at least one B, or (3) including both of at least one A and at least one B.

Terms such as “first” and “second” are used herein merely to describe a variety of constituent elements, but the constituent elements are not limited by the terms. Such terms are used only for the purpose of distinguishing one constituent element from another constituent element. For example, without departing from the right scope of the present inventive concept, a first constituent element may be referred to as a second constituent element, and vice versa.

In the present specification, when a constituent element, e.g., a first constituent element, is “(operatively or communicatively) coupled with/to” or is “connected to” another constituent element, e.g., a second constituent element, the constituent element contacts or is connected to the other constituent element directly or through at least one of other constituent elements, e.g., a third constituent element. Conversely, when a constituent element, e.g., a first constituent element, is described to “directly connect” or to be “directly connected” to another constituent element, e.g., a second constituent element, the constituent element should be construed to be directly connected to another constituent element without any other constituent element, e.g., a third constituent element, interposed therebetween. Other expressions, such as, “between” and “directly between”, describing the relationship between the constituent elements, may be construed in the same manner.

In the present specification, the expression “configured to” may be interchangeable with an expression such as “suitable for”, “having the capacity to”, “designed to”, “adapted to”, “made to”, or “capable of”. The expression “configured to” does not necessarily signify one that is “specifically designed to” in hardware. Instead, in some situations, the expression “configured to” may signify one that is “capable of” performing a function with other device or parts.

For example, an expression “a processor configured to perform functions A, B, and C” may signify an exclusive processor, for example, an embedded processor, for performing the functions or a generic-purpose processor, for example, a CPU or an application processor, capable of performing the functions by executing one or more software programs stored in a memory device.

The term “electronic apparatus” according to various embodiments of the present disclosure may include at least one of smartphones, tablet personal computers, mobile phones, video phones, e-book readers, desktop personal computers (PCs), laptop personal computers (PCs), netbook computers, workstations, servers, personal digital assistants (PDAs), portable multimedia players (PMPs), MP3 players, mobile medical devices, cameras, and wearable devices. According to various embodiments, a wearable device may include at least one of an accessory type, e.g., watches, rings, bracelets, anklets, necklaces, glasses, contact lenses, or a head-mounted devices (HMD), a fabric or garment integrated type, e.g., electronic apparel, a body attached type, e.g., skin pads or tattoos, or a body implantable type, e.g., implantable circuits.

In some embodiments, the electronic apparatus may be home appliances. Home appliances may include at least one of, for example, televisions, digital video disk (DVD) players, audio systems, refrigerators, air conditioners, vacuum cleaners, ovens, microwaves, washing machines, air cleaners, set-top boxes, home automation control panels, security control panels, TV boxes such as Samsung's HomeSync, Apple's TV™, or Google's TV™, game console such as Xbox™ or PlayStation™, electronic dictionaries, electronic keys, camcorders, and electronic photo frames.

In another embodiment, the electronic apparatus may include at least one of various medical devices such as various portable medical measuring instruments including a blood glucose meter, a heart rate meter, a blood pressure meter, or a temperature measuring instrument, magnetic resonance angiography (MRA), magnetic resonance imaging (MRI), computed tomography (CT), imaging apparatuses, or ultrasonic devices, navigation systems, global navigation satellite systems (GNSS), event data recorders (EDR), flight data recorders (FDR), automotive infotainment devices, marine electronic equipment such as a marine navigation system or a gyro compass, avionics, security devices, automobile head units, industrial or home robots, automotive teller's machines of financial institutions, points of sales (POS) of stores, and Internet of Things (IoT) devices such as light bulbs, various sensors, electric or gas meters, sprinkler devices, fire alarms, thermostats, street lights, toasters, exercise equipment, hot water tanks, heaters, boilers, etc.

In some embodiments, the electronic apparatus may include at least one of a part of furniture or a building/structure, an electronic board, an electronic signature receiving device, a projector, and a variety of measuring instruments, such as, a water, electricity, gas, or radio wave measuring instrument, etc. In various embodiments, the electronic apparatus may be one of the above-described devices and a combination thereof. In some embodiments, the electronic apparatus may be a flexible electronic apparatus. Furthermore, the electronic apparatus according to the present embodiment is not limited to the above-described devices, and may include a new electronic apparatus according to the development of technologies.

In the specification, the term “user” may indicate a user who uses the electronic apparatus or an apparatus that uses the electronic apparatus, for example, an artificial intelligent electronic apparatus.

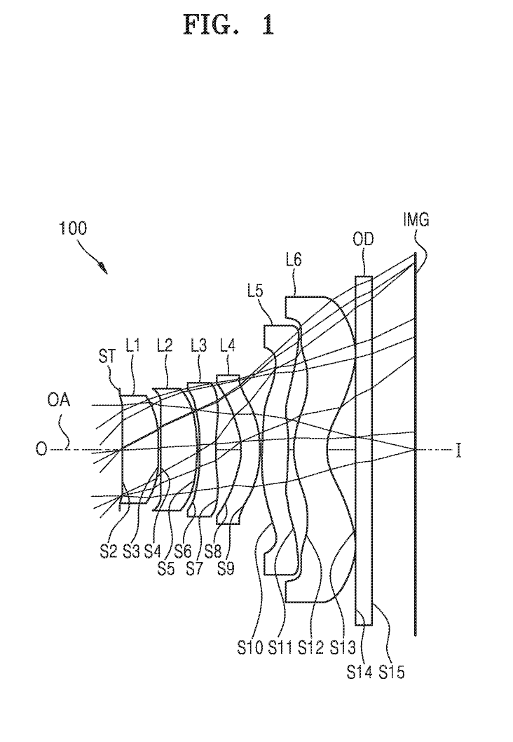

FIG. 1 is a schematic structural view of an optical lens assembly 100 according to a first embodiment.

The optical lens assembly 100 may include a first lens L1, a second lens L2, a third lens L3, a fourth lens L4, a fifth lens L5, and a sixth lens L6, which are arranged in order from an object side O to an image side I.

In the description of the configuration of the respective lenses, the image side I may denote, for example, a direction toward an image plane IMG where an image is formed, and the object side O may denote a direction toward an object. The object side O may indicate a direction toward the object on an assumption that a bent optical path is unfolded. Furthermore, an “object side surface” of a lens may denote, for example, a lens surface facing the object with respect to an optical axis OA, which signifies the left side in the drawing. An “image side surface” may denote, for example, a lens surface facing the image plane IMG with respect to an optical axis OA, which signifies the right side in the drawing. The image plane IMG may be, for example, an imaging device surface or an image sensor surface. An image sensor may include a sensor such as a complementary metal-oxide semiconductor (CMOS) image sensor or a charge-coupled device (CCD) image sensor. The image sensor is not limited thereto, and may be, for example, a device that converts an image of the object to an electric image signal.

The first lens L1 may have a positive refractive power. The first lens L1 may include an object side surface S2 that is convex toward the object side O. The first lens L1 may include an image side surface S3 that is convex toward the image side I. The second lens L2 may have a positive refractive power. The second lens L2 may include an object side surface S4 that is convex toward the object side O. The second lens L2 may include an image side surface S5 that is convex toward the image side I.

The third lens L3 may have a negative refractive power. The third lens L3 may include an object side surface S6 that is concave toward the object side O. The third lens L3 may include an image side surface S7 that is concave toward the image side I. The fourth lens L4 may have a negative refractive power. The fourth lens L4 may include an object side surface S8 that is concave toward the object side O. The fourth lens L4 may include an image side surface S9 that is convex toward the image side I. The fourth lens L4 may have a meniscus shape that is convex toward the image side I.

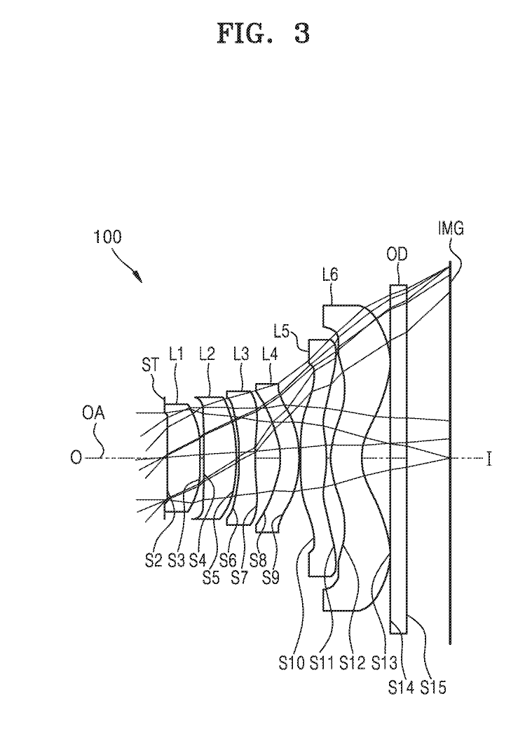

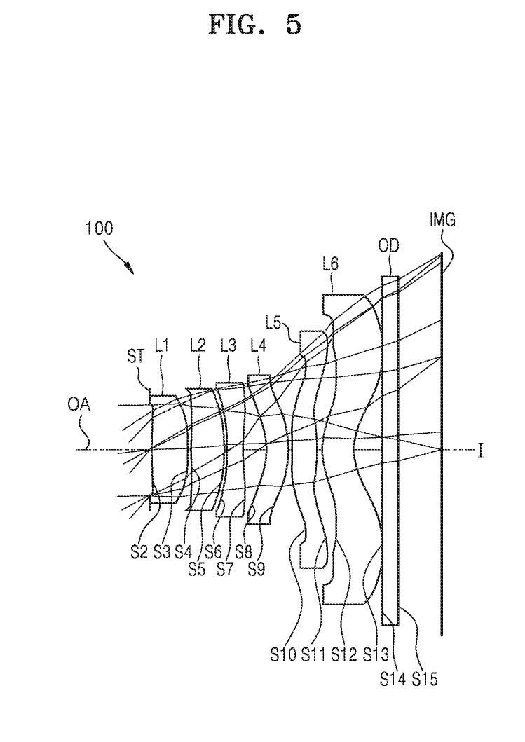

The fifth lens L5 may have a positive refractive power. The fifth lens L5 may have at least one inflection point on at least one of an object side surface S10 and an image side surface S11. The inflection point may denote a point at which the sign of a radius of curvature changes from (+) to (−) or from (−) to (+). Alternatively, the inflection point may denote a point at which the shape of a lens surface changes from convex to concave, or vice versa. The fifth lens L5 may include an object side surface S10 that is convex toward the object side O in an area around the optical axis OA. The area around the optical axis OA may denote an area within a certain radius from the optical axis OA. The object side surface S10 of the fifth lens L5 may have a convex shape in an area around the optical axis OA and a concave shape in an area farther from the optical axis OA. Alternatively, as illustrated in FIGS. 3 and 5, the fifth lens L5 may include the object side surface S10 that is convex toward the object side O in an area around the optical axis OA. The object side surface S10 of the fifth lens L5 may have a concave shape in an area around the optical axis OA and a convex shape in an area farther from the optical axis OA.

The fifth lens L5 may include an image side surface S11 that is convex toward the image side I in an area around the optical axis OA. The image side surface S11 of the fifth lens L5 may have a convex shape in an area around the optical axis OA and a concave shape in an area farther from the optical axis OA. The fifth lens L5 may have a biconvex shape in the area around the optical axis OA, or a meniscus shape in the area around the optical axis OA.

The sixth lens L6 may have a negative refractive power. The sixth lens L6 may include at least one inflection point on at least one of an object side surface S12 and an image side surface S13. The sixth lens L6 may include the object side surface S12 that is convex toward the object side O in an area around the optical axis OA. The object side surface S12 of the sixth lens L6 may have a convex shape in an area around the optical axis OA and a concave shape in an area farther from the optical axis OA. The sixth lens L6 may include the image side surface S13 that is concave toward the image side I in the area around the optical axis OA. The image side surface S13 of the sixth lens L6 may have a concave shape in an area around the optical axis OA and a convex shape in an area farther from the optical axis OA.

The optical lens assembly 100 according to the present embodiment may include at least one stop ST. The stop ST is to adjust the diameter of luminous flex and may include, for example, an aperture stop, a variable stop, or a mask-shaped stop. The stop ST may be arranged on, for example, the object side O of the first lens L1.

In the optical lens assemblies according to various embodiments, at least one of the object side surface and the image side surface of the fifth lens L5 may satisfy the following inequality.

|Sag_{Min}|+|Sag_{Max}|>SagD <Inequality 1>

In Inequality 1, “Sag_{Min}” may denote a distance on the optical axis OA from a vertex on the optical axis OA to the most concave point of the object side surface S10 of the fifth lens L5; “Sag_{Max}” may denote a distance on the optical axis OA from the vertex of the optical axis OA to the most convex point of the object side surface S10 of the fifth lens L5; and “SagD” may denote a distance on the optical axis OA from the vertex on the optical axis OA to a farthest point of an effective diameter of the fifth lens L5.

When at least one of the object side surface and the image side surface of the fifth lens L5 satisfies Inequality 1, aberration of the optical lens assemblies according to various embodiments may be corrected satisfactorily.

The optical lens assemblies according to various embodiments may satisfy the following inequality

20<FOV/TTL<30 <Inequality 2>

In Inequality 2, “FOV” may denote a field of view, and “TTL” may denote an overall length of the optical lens assembly. In the present embodiment, the overall length may denote a distance from the stop to the image plane IMG.

When the optical lens assemblies according to various embodiments satisfy Inequality 2, compact products having a short overall length may be manufactured, and an optical system having a relatively wide field of view may be implemented.

The optical lens assemblies according to various embodiments may satisfy the following inequality.

0.6<TTL/ImgH<0.8 <Inequality 3>

In Inequality 3, “TTL” may denote an overall length of an optical lens assembly and “ImgH” may denote an image height. When a value of (TTL/ImgH) is less than a lower limit of Inequality 3, the miniaturization of an optical lens assembly may be possible, but implementation of optical performance is difficult. When the value of (TTL/ImgH) is greater than an upper limit of Inequality 3, the miniaturization of an optical lens assembly is difficult.

The optical lens assemblies according to various embodiments may satisfy the following inequality.

0.4<F/ImgH<0.6 <Inequality 4>

In Inequality 4, “F” may denote a focal length, and “ImgH” may denote an image height. When a value of (F/ImgH) is less than a lower limit of Inequality 4, aberration control is difficult. When the value of (F/ImgH) is greater than an upper limit of Inequality 4, a focal length increases excessively and thus it is difficult to implement a wide angle.

The optical lens assemblies according to various embodiments may satisfy the following inequality.

0.3<D1/D6<0.5 <Inequality 5>

In Inequality 5, “D1” may denote an effective diameter of the first lens L1, and “D6” may denote an effective radius of the sixth lens L6. When a value of (D1/D6) satisfies Inequality 5, aberration control is easy.

The optical lens assemblies according to various embodiments may satisfy the following inequality.

1.5<(Ind3+Ind4)/2<1.7 <Inequality 6>

In Inequality 6, “Ind3” may denote a refractive index of the third lens L3, and “Ind4” may denote a refractive index of the fourth lens L4. When the third lens L3 and the fourth lens L4 satisfy Inequality 6, a lens may be manufactured with low cost materials and aberration may be easily reduced. For example, the optical lens assemblies according to various embodiments may include at least one plastic lens. For example, all lenses of the optical lens assemblies according to various embodiments are plastic lenses and thus manufacturing costs may be reduced and aberration may be easily corrected.

The optical lens assemblies according to various embodiments may have a field of view ranging from 85 to 95. Thus, an image of a wide field of view may be captured.

The optical lens assemblies according to various embodiments may have an F number ranging from 2.0 to 2.1. Thus, the optical lens assemblies according to various embodiments may capture a bright image.

At least one of lenses included in the optical lens assemblies according to various embodiments may be a plastic lens. For example, the first to sixth lenses L1, L2, L3, L4, L5, and L6 each may be plastic lenses. Thus, the manufacturing unit cost may be reduced.

An aspherical surface used in the optical lens assemblies according to various embodiments is defined as follows.

An aspherical shape may be expressed by the following equation assuming that an optical axis direction is an x-axis, a direction perpendicular to the optical axis direction is a y-axis, and a traveling direction of a light beam is set to be positive. In the equation, “x” may denote a distance from a vertex of a lens in the optical axis direction, “y” may denote a distance in a direction perpendicular to the optical axis, “K” may denote a conic constant, “A”, “B”, “C”, “D”, . . . may denote aspherical coefficients, and “c” may denote a reciprocal of radius of curvature (1/R) at the vertex of a lens.

$$x = \frac{{cy}^{2}}{1 + \sqrt{1 - ( K + 1 ) {c}^{2} {y}^{2}}} + {Ay}^{4} + {By}^{6} + {Cy}^{8} + {Dy}^{10} + … \qquad 〈 Equation 7 〉$$

At least one of the lenses included in the optical lens assemblies according to various embodiments may be an aspherical lens. For example, the first to sixth lenses L1, L2, L3, L4, L5, and L6 each may be an aspherical lens.

In the present embodiment, an optical lens assembly may be implemented through numerical embodiments according to various designs as follows.

In a table of each numerical embodiment, lens surface numbers of S1, S2, S3, . . . Sn, where n is a natural number, are assigned sequentially and serially from the object side O to the image side I. “F” may denote an overall focal length of an optical lens assembly, “FNo” may denote an F number, “2w” may denote a field of view, “OBJ” may denote an object, “R” may denote a radius of curvature, “T” may denote a thickness of a lens or an air gap between lenses, “Nd” may denote a refractive index, “Vd” may denote the Abbe number, “ST” may denote a stop, and “*” may denote an aspherical surface.

### First Embodiment

FIG. 1 illustrates the optical lens assembly 100 according to a first embodiment. Design data of the first embodiment are shown below.

FNo.=2.08, F=2.2969 mm, FOV: 90 degrees

TABLE 1

| Lens | | | | |
|---|---|---|---|---|
| surface | R | T | Nd | Vd |
| ST (S1) | Infinity | 0.0300 | | |
| S2* | 6.7569 | 0.4274 | 1.546 | 56.093 |
| S3* | −300.0000 | 0.0250 | | |
| S4* | 2.1422 | 0.4457 | 1.546 | 56.093 |
| S5* | −1.8792 | 0.0250 | | |
| S6* | −7.1150 | 0.2000 | 1.656 | 21.474 |
| S7* | 3.0557 | 0.3104 | | |
| S8* | −0.9366 | 0.2269 | 1.656 | 21.474 |
| S9* | −1.4858 | 0.0250 | | |
| S10* | 131.1908 | 0.3217 | 1.546 | 56.093 |
| S11* | −1.9834 | 0.0600 | | |
| S12* | 0.7253 | 0.4091 | 1.546 | 56.093 |
| S13* | 0.5720 | 0.3438 | | |
| S14 | Infinity | 0.2100 | | |
| S15 | Infinity | 0.5204 | | |
| IMG | Infinity | −0.0004 | | |

Table 2 shows aspherical coefficients in the first embodiment.

TABLE 2

| Lens | | | | | | | | | | |
|---|---|---|---|---|---|---|---|---|---|---|
| surface | K | A | B | C | D | E | F | G | H | J |
| S2 | −18.8013 | −0.0788 | −5.8407 | 95.4609 | −998.2125 | 6550.5032 | −2.7035e+004 | 6.7785e+004 | −9.4015e+004 | 5.5137e+004 |
| S3 | −27.9760 | −2.3861 | 14.3604 | −98.9051 | 559.0209 | −2259.6763 | 6158.1299 | −1.0804e+004 | 1.1070e+004 | −5045.5414 |
| S4 | −52.3904 | −1.3344 | 9.6720 | −73.3708 | 457.8764 | −1991.8129 | 5690.8307 | −1.0238e+004 | 1.0533e+004 | −4726.0029 |
| S5 | 0.0000 | 0.3410 | −4.6221 | 27.0596 | −89.6794 | 187.9591 | −313.3492 | 446.7570 | −420.0639 | 168.6563 |
| S6 | 67.1812 | −0.3831 | −0.7297 | 1.3082 | 36.9482 | −215.6165 | 506.3466 | −555.5382 | 236.0199 | 0.0000 |
| S7 | −110.1293 | −0.0354 | −1.1291 | 7.1312 | −31.8772 | 96.8746 | −200.2746 | 260.7841 | −191.9005 | 61.8335 |
| S8 | 0.0000 | 0.1310 | −0.0009 | 12.5240 | −80.2285 | 253.1326 | −451.1261 | 451.0612 | −229.0510 | 44.3853 |
| S9 | 0.0000 | 0.4972 | 2.4359 | −7.7059 | 14.0990 | −12.1652 | 4.0600 | 0.0000 | 0.0000 | 0.0000 |
| S10 | 24.7526 | 0.6927 | −0.5637 | −1.0187 | 2.4620 | −2.1436 | 0.8848 | −0.1491 | 0.0000 | 0.0000 |
| S11 | 0.0000 | 0.1702 | 3.4281 | −10.6699 | 15.7957 | −13.8604 | 7.5851 | −2.5522 | 0.4851 | −0.0400 |
| S12 | −6.7613 | 0.0074 | −0.8439 | 2.2508 | −3.3307 | 2.7802 | −1.2893 | 0.3113 | −0.0306 | 0.0000 |
| S13 | −2.5966 | −0.5265 | 0.8573 | −1.0284 | 0.8364 | −0.4648 | 0.1750 | −0.0427 | 0.0061 | −0.0004 |

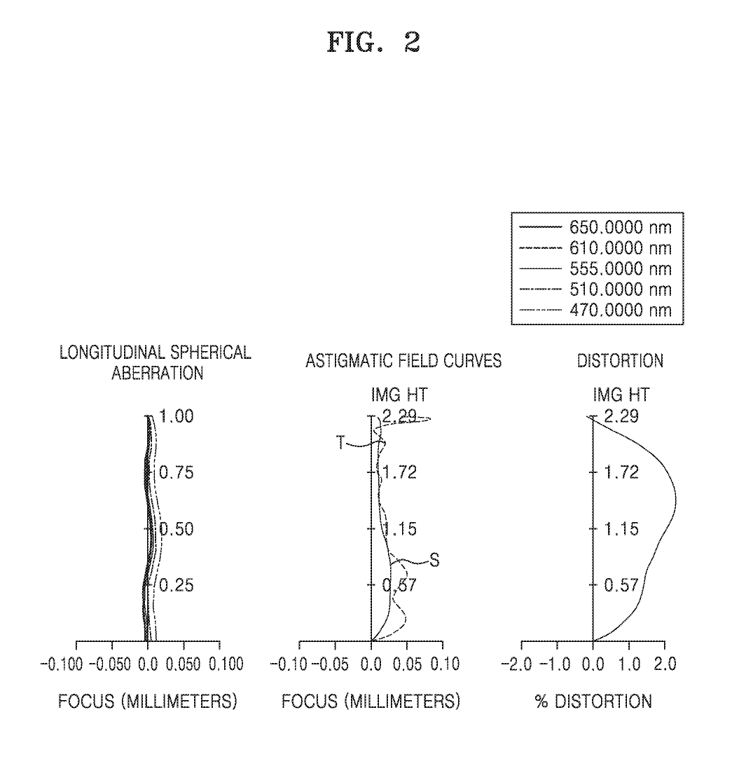

FIG. 2 is a graph respectively showing longitudinal spherical aberration, astigmatic field curves, and distortion of the optical lens assembly of FIG. 1. The longitudinal spherical aberration is obtained with respect to light having a wavelength of, for example, 650.0000 nanometers (NM), 610.000 NM, 565.0000 NM, 510.0000 NM, or 476.0000 NM. The astigmatic field curves may include tangential field curvature T and sagittal field curvature S. The astigmatic field curves are obtained with respect to light having a wavelength of 565.0000 NM. The distortion is obtained with respect to light having a wavelength of 565.0000 NM. The descriptions on the aberration graphs may be identically applied to other numerical embodiments.

### Second Embodiment

FIG. 3 illustrates an optical lens assembly according to a second embodiment. Table 3 shows the design data of the second embodiment.

FNo.=2.08, F=2.2964 mm, FOV: 90 degrees

TABLE 3

| Lens | | | | |
|---|---|---|---|---|
| surface | R | T | Nd | Vd |
| ST (S1) | Infinity | 0.0300 | | |
| S2* | 5.9891 | 0.4285 | 1.546 | 56.093 |
| S3* | −300.0000 | 0.0250 | | |
| S4* | 2.2534 | 0.4377 | 1.546 | 56.093 |
| S5* | −1.8625 | 0.0250 | | |
| S6* | −7.0529 | 0.2000 | 1.656 | 21.474 |
| S7* | 3.0352 | 0.3087 | | |
| S8* | −0.9388 | 0.2286 | 1.656 | 21.474 |
| S9* | −1.4782 | 0.0250 | | |
| S10* | −656.7220 | 0.3190 | 1.546 | 56.093 |
| S11* | −2.0011 | 0.0600 | | |
| S12* | 0.7377 | 0.4199 | 1.546 | 56.093 |
| S13* | 0.5865 | 0.3426 | | |
| S14 | Infinity | 0.2100 | | |
| S15 | Infinity | 0.5197 | | |
| IMG | Infinity | 0.0003 | | |

Table 4 shows aspherical coefficients in the second embodiment.

TABLE 4

| Lens | | | | | | | | | | |
|---|---|---|---|---|---|---|---|---|---|---|
| surface | K | A | B | C | D | E | F | G | H | J |
| S2 | −18.8013 | −0.0618 | −6.1818 | 103.1602 | −1096.8154 | 7315.5664 | −3.0715e+004 | 7.8515e+004 | −1.1136e+005 | 6.7058e+004 |
| S3 | −27.9760 | −2.3193 | 14.1832 | −104.1511 | 630.0395 | −2691.5607 | 7655.1880 | −1.3845e+004 | 1.4447e+004 | −6631.3307 |
| S4 | −52.3904 | −1.3531 | 9.8956 | −77.5883 | 496.8964 | −2187.4383 | 6272.1087 | −1.1270e+004 | 1.1554e+004 | −5164.6238 |
| S5 | 0.0000 | 0.3393 | −4.8132 | 29.5320 | −105.6223 | 252.9232 | −482.3827 | 718.4676 | −665.1193 | 262.8366 |
| S6 | 67.1812 | −0.3867 | −0.8126 | 1.7133 | 36.2522 | −217.1454 | 515.7132 | −570.7247 | 244.4812 | 0.0000 |
| S7 | −103.5783 | −0.0351 | −1.1256 | 7.0931 | −31.7890 | 96.6332 | −199.3630 | 258.6390 | −189.4028 | 60.7794 |
| S8 | 0.0000 | 0.1319 | 0.0025 | 12.5163 | −80.4895 | 254.9948 | −456.7709 | 460.0620 | −236.4712 | 46.8551 |
| S9 | 0.0000 | −0.5095 | 2.5314 | −7.9887 | 14.4557 | −12.3008 | 4.0319 | 0.0000 | 0.0000 | 0.0000 |
| S10 | 24.7526 | 0.6987 | −0.5526 | −1.0908 | 2.6076 | −2.2873 | 0.9571 | −0.1636 | 0.0000 | 0.0000 |
| S11 | 0.0000 | 0.1923 | 3.2786 | −10.2814 | 15.2105 | −13.3026 | 7.2486 | −2.4290 | 0.4602 | −0.0379 |
| S12 | −7.0610 | 0.0426 | −0.8939 | 2.2480 | −3.2448 | 2.6791 | −1.2356 | 0.2974 | −0.0292 | 0.0000 |
| S13 | −2.6641 | −0.4859 | 0.7786 | −0.9338 | 0.7728 | −0.4343 | 0.1649 | −0.0405 | 0.0058 | −0.0004 |

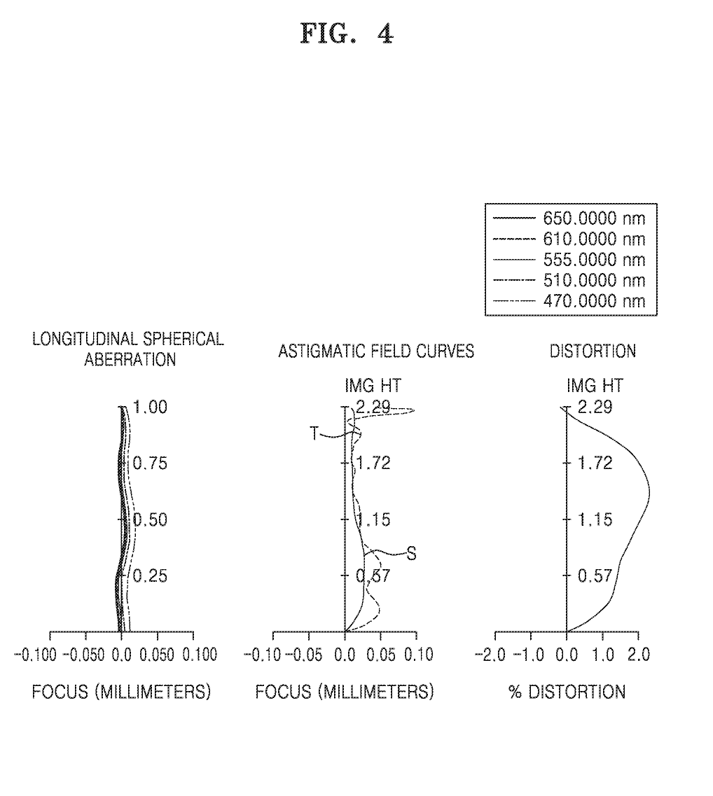

FIG. 4 is a graph respectively showing longitudinal spherical aberration, astigmatic field curves, and distortion of the optical lens assembly of FIG. 3.

### Third Embodiment

FIG. 5 illustrates an optical lens assembly according to a third embodiment. Table 5 shows the design data of the third embodiment.

FNo.=2.08, F=2.2935 mm, FOV: 90 degrees

TABLE 5

| Lens | | | | |
|---|---|---|---|---|
| surface | R | T | Nd | Vd |
| ST (S1) | Infinity | 0.0300 | | |
| S2* | 5.5255 | 0.4383 | 1.546 | 56.093 |
| S3* | −300.0000 | 0.0300 | | |
| S4* | 2.0947 | 0.4233 | 1.546 | 56.093 |
| S5* | −2.0520 | 0.0300 | | |
| S6* | −5.9059 | 0.2000 | 1.656 | 21.474 |
| S7* | 3.0972 | 0.2752 | | |
| S8* | −0.9816 | 0.2657 | 1.656 | 21.474 |
| S9* | −1.5448 | 0.0300 | | |
| S10* | −69.6133 | 0.3134 | 1.546 | 56.093 |
| S11* | −1.5990 | 0.0600 | | |
| S12* | 0.7166 | 0.3879 | 1.546 | 56.093 |
| S13* | 0.5201 | 0.3661 | | |
| S14 | Infinity | 0.2100 | | |
| S15 | Infinity | 0.5159 | | |
| IMG | Infinity | 0.0041 | | |

Table 6 shows aspherical coefficients in the third embodiment.

TABLE 6

| Lens | | | | | | | | | | |
|---|---|---|---|---|---|---|---|---|---|---|
| surface | K | A | B | C | D | E | F | G | H | J |
| S2 | −18.8013 | −0.0266 | −6.8648 | 109.8832 | −1117.4734 | 7112.3419 | −2.8491e+004 | 6.9485e+004 | −9.4033e+004 | 5.4000e+004 |
| S3 | −27.9760 | −1.9788 | 10.0088 | −78.3724 | 503.3871 | −2168.1982 | 6005.5332 | −1.0361e+004 | 1.0184e+004 | −4370.4602 |
| S4 | −52.3904 | −0.8747 | 6.0602 | −63.3302 | 466.2292 | −2137.0027 | 6144.5129 | −1.0912e+004 | 1.0987e+004 | −4805.4710 |
| S5 | 0.0000 | −0.0171 | 1.3429 | −22.4787 | 136.6614 | −384.4419 | 435.9158 | 108.0819 | −629.0891 | 365.4086 |
| S6 | 45.1404 | −0.9788 | 6.3391 | −52.9742 | 289.0241 | −898.2316 | 1566.6942 | −1426.5893 | 525.9181 | 0.0000 |
| S7 | −219.8588 | −0.0487 | −1.0895 | 6.3939 | −25.5075 | 75.5989 | −155.3655 | 200.1690 | −142.2641 | 42.2013 |
| S8 | 0.0000 | 0.1587 | 0.0493 | 12.3713 | −81.1908 | 264.7528 | −496.0917 | 540.7756 | −318.9041 | 78.9658 |
| S9 | 0.0000 | −0.4647 | 2.2039 | −6.7401 | 12.7103 | −11.4650 | 3.9684 | 0.0000 | 0.0000 | 0.0000 |
| S10 | 24.7526 | 0.6311 | −0.2328 | −1.5827 | 3.0373 | −2.5494 | 1.0595 | −0.1808 | 0.0000 | 0.0000 |
| S11 | 0.0000 | 0.1670 | 4.1623 | −12.8216 | 19.3952 | −17.6904 | 10.1599 | −3.6029 | 0.7220 | −0.0626 |
| S12 | −7.5599 | −0.1312 | −0.1108 | 0.6639 | −1.2333 | 1.1001 | −0.5102 | 0.1194 | −0.0112 | 0.0000 |
| S13 | −3.2025 | −0.4003 | 0.6383 | −0.7178 | 0.5230 | −0.2516 | 0.0796 | −0.0159 | 0.0018 | −9.3813e−005 |

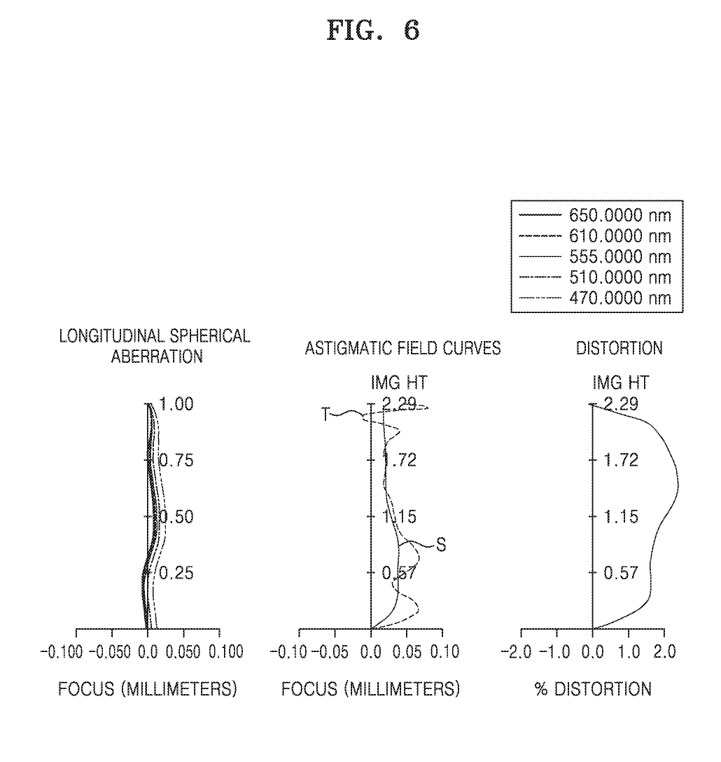

FIG. 6 is a graph respectively showing longitudinal spherical aberration, astigmatic field curves, and distortion of the optical lens assembly of FIG. 5.

In the following description, the longitudinal spherical aberration, the astigmatic field curves, and the distortion are discussed.

The following table shows that optical lens assemblies according to various embodiments satisfy Conditional Expression 1 to Conditional Expression 8.

TABLE 7

| | | Conditional | | | | | | |
|---|---|---|---|---|---|---|---|---|
| | | Expression 2 | | | | | | |
| | Conditional | ISag | Conditional | Conditional | Conditional | Conditional | Conditional | Conditional |
| | Expression 1 | MinI + ISag | Expression 3 | Expression 4 | Expression 5 | Expression 6 | Expression 7 | Expression 8 |
| | FOV | MaxI > SagD | FOV/TTL | TTL/ImgH | F/ImgH | FNo | D1/D6 | (Ind3 + Ind4)/2 |
| First embodiment | 90.000 | 0.1498 > | 25.352 | 0.774433 | 0.501069 | 2.080 | 0.349807 | 1.867872 |
| | | 0.0762 | | | | | | |
| Second | 90.000 | 0.1605 > | 25.352 | 0.774433 | 0.50096 | 2.080 | 0.364284 | 1.867872 |
| embodiment | | 0.0792 | | | | | | |
| Third | 90.000 | 0.157 > | 25.352 | 0.774433 | 0.500327 | 2.080 | 0.451596 | 1.867872 |
| embodiment | | 0.0509 | | | | | | |

The optical lens assemblies according to various embodiments may be applied to, for example, an electronic apparatus adopting an image sensor. The optical lens assembly according to an embodiment may be applied to various electronic apparatuses such as digital cameras, interchangeable lens cameras, video cameras, mobile phone cameras, cameras for small mobile devices, etc.

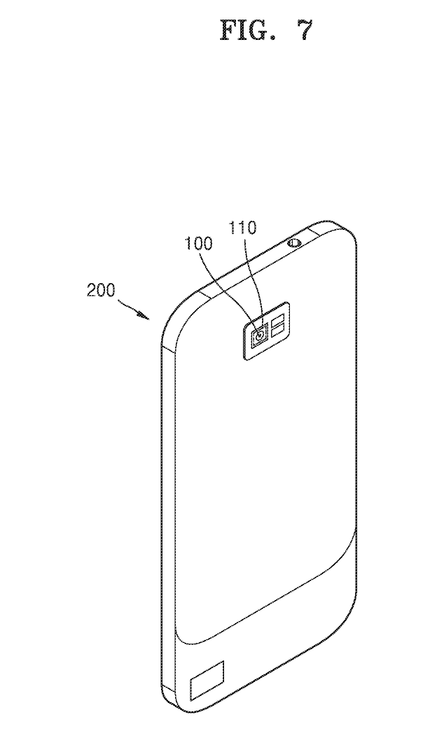

FIG. 7 illustrates an example of an electronic apparatus 200 including an optical lens assembly according to an embodiment. Although FIG. 7 illustrates an example in which the electronic apparatus 200 is applied to a mobile phone, the present disclosure is not limited thereto. The electronic apparatus 200 may include an optical lens assembly 100 and an image sensor 110 that receives an image formed by the optical lens assembly 100 and converts the received image to an electric image signal. The optical lens assemblies described with reference to FIGS. 1 to 6 may be employed as the optical lens assembly 100. As the optical lens assemblies according to various embodiments are applied to imaging apparatuses such as compact digital cameras or mobile phones, an imaging apparatus capable of imaging with high performance may be implemented.

The image sensor 110 may include a sensor, for example, a complementary metal-oxide semiconductor (CMOS) image sensor or a charge-coupled device (CCD) image sensor.

The image sensor 110 may include pixels capable of sensing infrared rays. An infrared sensitive pixel may enable photographing of infrared rays in a situation where photographing visible light is difficult, for example, indoors or at night. A color filter included in an image sensor may not only transmit lights of wavelengths corresponding to red, green, and blue, but also light of a wavelength in an infrared range. Accordingly, when the wavelength in an infrared ray range is not blocked, noise is generated in color reproduction. The infrared ray may be blocked by using a separate filter or coating. In some embodiments, an infrared ray shield film is arranged, for example, between the most image side lens of the optical lens assembly 100 and the image sensor 110, and the infrared ray shield film may be moved by an actuator. Thus, the infrared ray shield film may be deviated from the optical path when necessary. When an image sensor having the infrared sensitive pixel is used, to photograph light having a visible light wavelength, infrared rays are blocked by the infrared ray shield film. When the infrared ray shield film is not used, infrared ray noise may be removed by using a processor. When infrared rays are photographed, the infrared ray shield film is moved and an infrared image may be obtained by using the infrared sensitive pixel.

The electronic apparatus illustrated in FIG. 7 is a general example and may be applied to various optical devices. For example, a wide-angle lens according to the present embodiment may be applied to a lens system of a camera for vehicles. Furthermore, the wide-angle lens may be applied to virtual reality devices, augmented reality devices, etc. For example, in a virtual reality device, the wide-angle lenses according to the above-described embodiment may be provided to face opposite directions. For example, various vehicle devices such as black boxes, around view monitoring (AVM) systems, or rear cameras may adopt the wide-angle lens according to the above-described embodiment. Furthermore, the wide-angle lens may be applied to various action cameras such as cameras for drones or leisure sports. In addition, the wide-angle lens may be applied to various surveillance cameras.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. An optical lens assembly comprising, in order from an object side to an image side:
a first lens having a positive refractive power;
a second lens having a positive refractive power;
a third lens having a negative refractive power;
a fourth lens having a negative refractive power;
a fifth lens having a positive refractive power and having at least one inflection point on at least one of an object side surface and an image side surface; and
a sixth lens having a negative refractive power.

2. The optical lens assembly of claim 1, satisfying an inequality:

|Sag_{Min}|+|Sag_{Max}|>SagD,
wherein “Sag_{Min}” denotes a distance from an optical axis to a most concave point of the fifth lens, “Sag_{Max}” denotes a distance from the optical axis to a most convex point of the fifth lens, and “SagD” denotes a distance from the optical axis to a farthest point of an effective diameter of the fifth lens.

3. The optical lens assembly of claim 1, satisfying an inequality:
20<FOV/TTL<30,
wherein “FOV” denotes a field of view and “TTL” denotes an overall length of the optical lens assembly.

4. The optical lens assembly of claim 1, satisfying an inequality:
0.6<TTL/ImgH<0.8,
wherein “TTL” denotes an overall length of the optical lens assembly and “ImgH” denotes an image height.

5. The optical lens assembly of claim 1, satisfying an inequality:
0.4<F/ImgH<0.6,
wherein “F” denotes a focal length and “ImgH” denotes an image height.

6. The optical lens assembly of claim 1, satisfying an inequality:
0.3<D1/D6<0.5,
wherein “D1” denotes an effective diameter of the first lens and “D6” denotes an effective diameter of the sixth lens.

7. The optical lens assembly of claim 1, satisfying an inequality:
1.5<(Ind3+Ind4)/2<1.7,
wherein “Ind3” denotes a refractive index of the third lens and “Ind4” denotes a refractive index of the fourth lens.

8. The optical lens assembly of claim 1, wherein the optical lens assembly has a field of view ranging from about 85 to about 95.

9. The optical lens assembly of claim 1, wherein the optical lens assembly has an F number ranging from about 2.0 to about 2.1.

10. The optical lens assembly of claim 1, wherein the second lens comprises an image side surface that is convex toward the image side.

11. The optical lens assembly of claim 1, wherein the third lens comprises an image side surface that is concave toward the image side and the fourth lens comprises a meniscus shape that is convex toward the image side.

12. An optical lens assembly comprising, in order from an object side to an image side:
a first lens having a positive refractive power;
a second lens having a positive refractive power;
a third lens having a negative refractive power;
a fourth lens having a negative refractive power;
a fifth lens having a positive refractive power; and
a sixth lens having a negative refractive power,
wherein the optical lens assembly satisfies an inequality:
0.3<D1/D6<0.5,
wherein “D1” denotes an effective diameter of the first lens and “D6” denotes an effective diameter of the sixth lens.

13. The optical lens assembly of claim 12, satisfying an inequality:

|Sag_{Min}|+|Sag_{Max}|>SagD,
wherein “Sag_{Min}” denotes a distance from an optical axis to a most concave point of the fifth lens, “Sag_{Max}” denotes a distance from the optical axis to a most convex point of the fifth lens, and “SagD” denotes a distance from the optical axis to a farthest point of an effective diameter of the fifth lens.

14. The optical lens assembly of claim 12, satisfying an inequality:
20<FOV/TTL<30,
wherein “FOV” denotes a field of view and “TTL” denotes an overall length of the optical lens assembly.

15. The optical lens assembly of claim 12, satisfying an inequality:
0.6<TTL/ImgH<0.8,
wherein “TTL” denotes an overall length of the optical lens assembly and “ImgH” denotes an image height.

16. The optical lens assembly of claim 12, satisfying an inequality:
0.4<F/ImgH<0.6,
wherein “F” denotes a focal length and “ImgH” denotes an image height.

17. The optical lens assembly of claim 12, wherein the optical lens assembly has a field of view ranging from about 85 to about 95.

18. The optical lens assembly of claim 12, wherein the optical lens assembly has an F number ranging from about 2.0 to about 2.1.

19. The optical lens assembly of claim 12, wherein the second lens comprises an image side surface that is convex toward the image side, the third lens comprises an image side surface that is concave toward the image side, and the fourth lens comprises a meniscus shape that is convex toward the image side.

20. An electronic apparatus comprising:
an optical lens assembly; and
an image sensor capturing an image formed by the optical lens assembly,
wherein the optical lens assembly comprises, in order from an object side to an image side:
a first lens having a positive refractive power;
a second lens having a positive refractive power;
a third lens having a negative refractive power;
a fourth lens having a negative refractive power;
a fifth lens having a positive refractive power and having at least one inflection point on at least one of an object side surface and an image side surface; and
a sixth lens having a negative refractive power.
